(19) United States
(12) Patent Application Publication
(10) Pub. No.: US 2025/0065978 A1
(43) Pub. Date: Feb. 27, 2025

(54) STEERING SYSTEM AND SCOOTER INCLUDING THE SAME

(71) Applicant: Anita Wu, Dongguan City (CN)

(72) Inventor: Neil Owen, Dongguan City (CN)

(21) Appl. No.: 18/456,006

(22) Filed: Aug. 25, 2023

(51) Int. Cl. B62K 21/02; B62K 21/10

(52) U.S. Cl. CPC B62K 21/02; B62K 21/10; B62K 2201/04

(57) ABSTRACT

A steering system includes: a base including a first structure and an axial hole defining an axial direction; a shaft rotatably inserted in the axial hole; a rotatable seat including a second structure located on a side of the rotatable seat facing the base, the rotatable seat being connected to and movable with the shaft; and at least one elastic member arranged around the axial direction and abutted against and between the first and second structures, wherein when the rotatable seat rotates relative to the base, the at least one elastic member is forced by the first and second structures and generates a deformation around the axial direction. A scooter includes the steering system, and further includes: a deck connected to the base; a steering mechanism including the shaft; and a plurality of wheels connected to the deck and the rotatable seat, respectively.

### BACKGROUND OF THE INVENTION

### Field of the Invention

The present invention relates to a steering system and a scooter including the same.

### Description of the Prior Art

Scooters have become more and more popular and widely used as portable means of transportation or sports equipment. Some of the conventional scooters are provided without a steering restoring mechanism, so manual restoring of the steering mechanism of the scooter is required after steering, which is inconvenient to operate.

In some conventional scooters, a spring is disposed between the front end of the deck and the front wheel shaft to restore the steering mechanism after steering. However, this kind of restoring mechanism is entirely arranged outside the steering rod, and there is no direct interaction between the spring in the conventional structure and the steering rod. As such, restoring effect and response speed are not satisfied. Furthermore, the conventional restoring structure is complicated, has a relatively unstable configuration, and has a poor restoring ability.

The present invention is, therefore, arisen to obviate or at least mitigate the above-mentioned disadvantages.

### SUMMARY OF THE INVENTION

The main object of the present invention is to provide a steering system and a scooter including the same which can efficiently generate a better restoring force and can be restored effectively and quickly, and which provides a simple structure and is easy to assemble and disassemble.

To achieve the above and other objects, a steering system is provided, wherein the steering system includes: a base including a first structure and an axial hole, the axial hole defining an axial direction; a shaft rotatably inserted in the axial hole; a rotatable seat including a second structure, the second structure being located on a side of the rotatable seat facing the base, the rotatable seat being connected to and movable with the shaft; and at least one elastic member arranged around the axial direction and abutted against and between the first structure and the second structure, wherein when the rotatable seat rotates relative to the base, the at least one elastic member is forced by the first structure and the second structure and generates a deformation around the axial direction.

To achieve the above and other objects, a scooter is provided, wherein the scooter includes the steering system, and further includes: a deck connected to the base; a steering mechanism including the shaft; and a plurality of wheels connected to the deck and the rotatable seat, respectively.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of an exemplary embodiment of the present invention;

FIG. 2 is a breakdown drawing of an exemplary embodiment of the present invention;

FIG. 3 is another breakdown drawing of an exemplary embodiment of the present invention;

FIG. 4 is a cross-sectional view of an exemplary embodiment of the present invention;

FIG. 5 is a drawing showing operation of a steering system according to an exemplary embodiment of the present invention; and

FIG. 6 is a stereogram of a scooter according to an exemplary embodiment of the present invention.

### DETAILED DESCRIPTION OF THE PREFERRED EMBODIMENTS

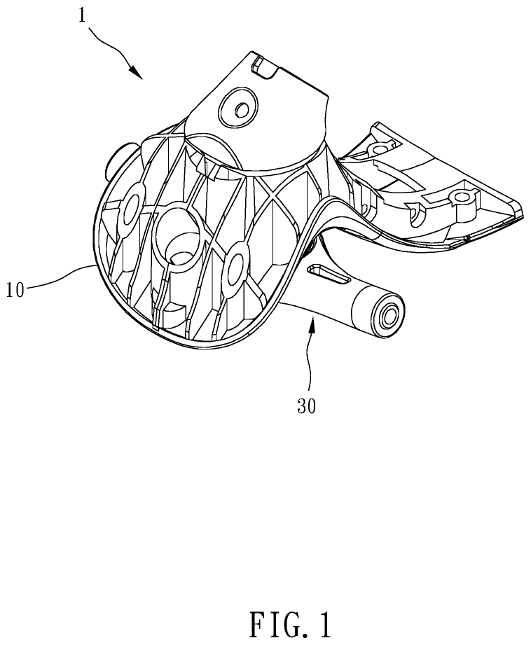

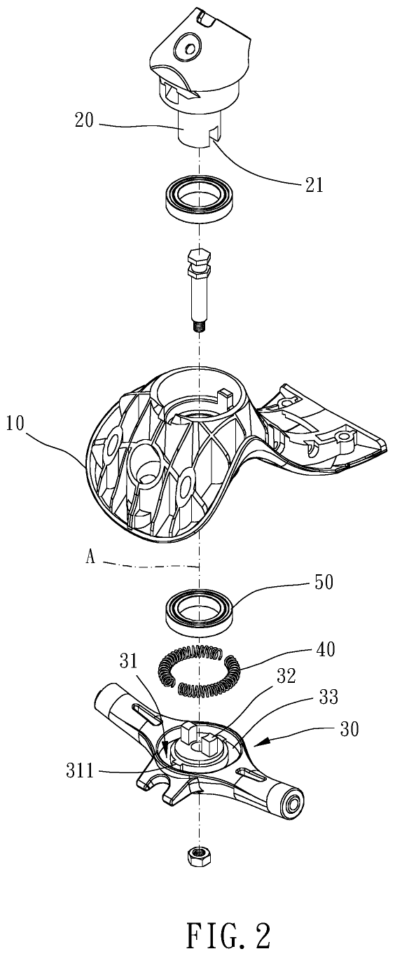

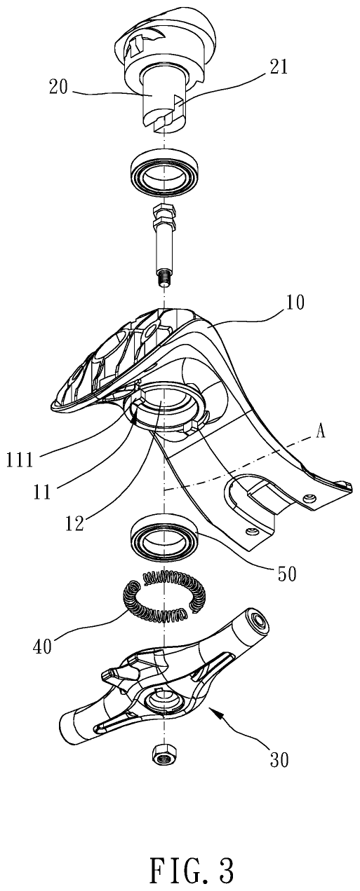

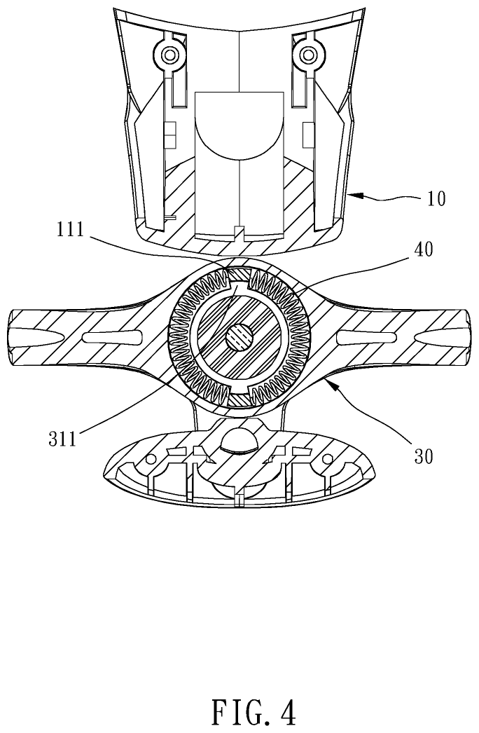

Please refer to FIGS. 1 to 5 for an exemplary embodiment of the present invention. A steering system 1 of the present invention includes a base 10, a shaft 20, a rotatable seat 30 and at least one elastic member 40.

The base 10 includes a first structure 11 and an axial hole 12, and the axial hole 12 defines an axial direction A. The shaft 20 is rotatably inserted in the axial hole 12. The rotatable seat 30 includes a second structure 31, the second structure 31 is located on a side of the rotatable seat 30 facing the base 10, and the rotatable seat 30 is connected to and movable with the shaft 20. The at least one elastic member 40 is arranged around the axial direction A, and is abutted against and between the first structure 11 and the second structure 31. When the rotatable seat 30 rotates relative to the base 10, the at least one elastic member 40 is forced by the first structure 11 and the second structure 31 and generates a deformation around (preferably centrally around) the axial direction A. As such, the at least one elastic member 40 can efficiently generate a better restoring force in the direction of rotation of the rotatable seat 30, so that the rotatable seat 30 can be restored effectively and quickly and so that it provides a simple structure and is easy to assemble and disassemble.

In this embodiment, the shaft 20 and the rotatable seat 30 are engaged with each other in the axial direction A so that they are stably assembled and rotatable quite simultaneously. Alternatively, the shaft 20 and the rotatable seat 30 may be connected to each other by pining, locking, snapping, buckling, welding or the like. Preferably, at least one bearing 50 is disposed between the shaft 20 and the rotatable seat 30, which is smooth in rotation with low wear. Specifically, the shaft 20 includes at least one slot 21, the rotatable seat 30 further includes at least one protrusion 32, and the at least one protrusion 32 is axially inserted in the at least one slot 21. Preferably, the shaft 20 includes two slots 21 radially separated from each other, and the rotatable seat 30 includes two protrusion 32 radially separated from each other, thus providing high structural strength and good rotational driving performance. It is noted that the rotatable seat 30 may include the at least one protrusion 32, while the shaft 20 includes the at least one slot 21.

The first structure 11 includes at least one projection 111, the second structure 31 includes at least one blocking portion 311, and the at least one elastic member 40 is abutted against and between the at least one projection 111 and the at least one blocking portion 311. The rotatable seat 30 further includes a recess 33 arranged around the axial direction A, the at least one blocking portion 311 is received within the recess 33, and the at least one elastic member 40 extends within and along the recess 33. The recess 33 can stably maintain the at least one elastic member 40, and can effectively and reliably guide the at least one elastic member 40 to generate reliably elastic deformation around the axial direction A.

Specifically, the at least one blocking portion 311 projects radially outward, the at least one projection 111 is located radially outside the at least one blocking portion 311, the recess 33 is arranged centrally around the axial direction A, the at least one projection 111 extends to be within the recess 33, and the at least one projection 111 corresponds to the at least one blocking portion 311 radially (or may be axially). As such, the at least one projection 111 and the at least one elastic member 40 are abutted against each other in a large contact area, which helps stabilize and effectively deform the at least one elastic member 40. Preferably, at least one intermediate member may be interposed between the at least one projection 111 and the at least one elastic member 40 or/and between the at least one blocking portion 311 and the at least one elastic member 40, so that it can apply force more smoothly and efficiently to the at least one elastic member 40

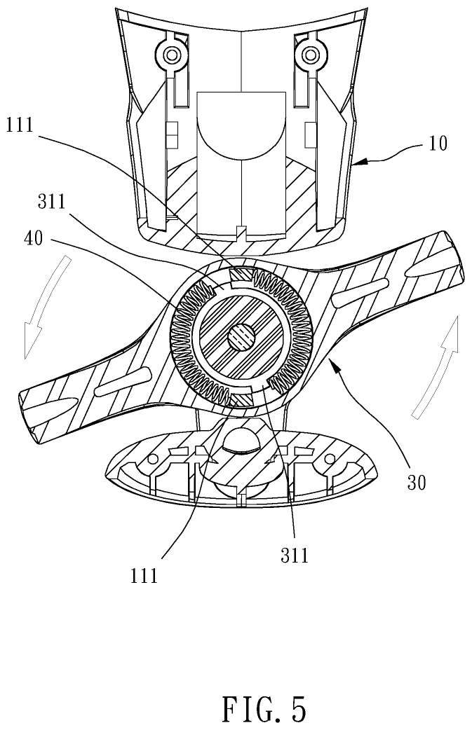

In this embodiment, the steering system 1 includes two elastic members 40, the first structure 11 includes two projections 111 radially separated from each other, the rotatable seat 30 includes two blocking portions 311 radially separated from each other, and the two elastic members 40 are abutted against and between opposing sides of the two blocking portions 311, respectively. As such, it provides equal, stable, and double recovery force in opposing directions (as shown in FIG. 5). The at least one elastic member 40 is a coil compression spring; however, the at least one elastic member 40 may be a tension spring, elastic rubber body, elastic reed or other elastic members. The at least one elastic member 40 is preferably applied with a preloading force and abutted against and between the at least one projection 111 and the at least one blocking portion 311, so that it can increase the restoring force and ensure that the steering system 1 is actually restored when it is not forced.

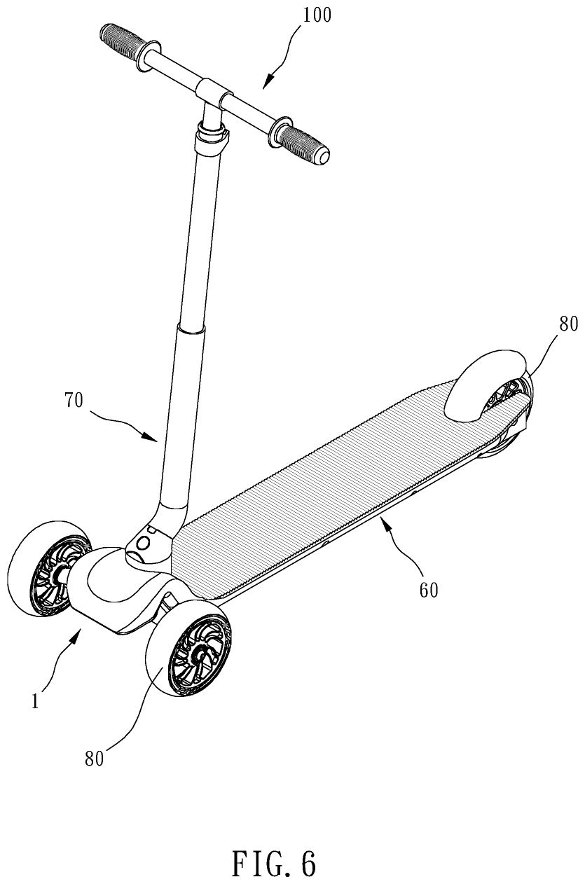

Please refer to FIG. 6, the invention further provides a scooter 100. The scooter 100 includes the steering system 1, and further includes a deck 60, a steering mechanism 70 and a plurality of wheels 80. The deck 60 is connected to the base 10, the steering mechanism 70 includes the shaft 20, and the plurality of wheels 80 are connected to the deck 60 and the rotatable seat 30, respectively.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A steering system including:
a base including a first structure and an axial hole, the axial hole defining an axial direction;
a shaft rotatably inserted in the axial hole;
a rotatable seat including a second structure, the second structure being located on a side of the rotatable seat facing the base, the rotatable seat being connected to and movable with the shaft; and
at least one elastic member arranged around the axial direction and abutted against and between the first structure and the second structure, wherein when the rotatable seat rotates relative to the base, the at least one elastic member is forced by the first structure and the second structure and generates a deformation around the axial direction.

2. The steering system of claim 1, wherein the shaft and the rotatable seat are engaged with each other in the axial direction.

3. The steering system of claim 2, wherein the shaft includes at least one slot, and the rotatable seat further includes at least one protrusion axially inserted in the at least one slot.

4. The steering system of claim 1, wherein the first structure includes at least one projection, the second structure includes at least one blocking portion, and the at least one elastic member is abutted against and between the at least one projection and the at least one blocking portion.

5. The steering system of claim 4, wherein the rotatable seat further includes a recess arranged around the axial direction, the at least one blocking portion is received within the recess, and the at least one elastic member extends within and along the recess.

6. The steering system of claim 5, wherein the at least one projection extends to be within the recess.

7. The steering system of claim 6, wherein the at least one projection corresponds to the at least one blocking portion radially.

8. The steering system of claim 5, wherein the deformation of the at least one elastic member is centrally around the axial direction, the at least one elastic member includes two elastic members, the at least one projection includes two projections radially separated from each other, the at least one blocking portion includes two blocking portions radially separated from each other, and the two elastic members are abutted against and between opposing sides of the two blocking portions, respectively.

9. The steering system of claim 7, wherein the at least one elastic member is a coil compression spring, and the at least one elastic member is applied with a preloading force and abutted against and between the at least one projection and the at least one blocking portion; the at least one blocking portion projects radially outward, and the at least one projection is located radially outside the at least one blocking portion; the recess extends centrally around the axial direction.

10. A scooter including the steering system, and further including:
a deck connected to the base;
a steering mechanism including the shaft; and
a plurality of wheels connected to the deck and the rotatable seat, respectively.
